(19) United States
(12) Patent Application Publication
(10) Pub. No.: US 2015/0007113 A1
(43) Pub. Date: Jan. 1, 2015

(54) VOLUME RENDERING FOR GRAPH RENDERIZATION

(71) Applicant: Silicon Graphics International Corp., Fremont, CA (US)

(72) Inventor: Marc David Hansen, Morgan Hill, CA (US)

(21) Appl. No.: 13/931,797

(22) Filed: Jun. 28, 2013

(51) Int. Cl. G06F 3/0481; G06F 3/0484

(52) U.S. Cl. CPC G06F 3/04815; G06F 3/04845
USPC 715/848

(57) ABSTRACT

Data visualization is provided with the capability to substitute elements for groups of clustered data in a graphical interface. When large numbers of data points are to be displayed in an interface, one or more groupings of data existing close together in coordinate space may be identified within the data. Once the groupings are identified and created, an element representing each grouping may be displayed in the visualization interface along with data points not associated with a grouping. A user may select a grouping to see additional information about the grouping, such as a zoomed-in view of the data points making up the grouping. Similarly, a user may select a portion of the data points that make up a grouping to display the element and zoom out for a broader view of the data.

### BACKGROUND

1. Field of the Invention

The present invention relates to visualization of data. In particular, the present invention relates to visualization of two or three dimensional data using volume rendering.

2. Description of the Prior Art

Visualization of data in two or three dimensional graphs can be helpful to understand complicated and large amounts of data. For big data type applications, the number of data points can be in the exabyte range. For this much data, typical graphical techniques do not provide a mechanism for understanding the data patterns and relationships in an uncluttered manner

Viewing two or three dimensional data sets associated with big data applications is not practical in typical graphical formats. When large numbers of data points are displayed in a visualization interface, the data can appear cluttered and the information normally relayed by the graphical presentation is not useable. What is needed is an improved visualization interface for displaying data as desired by a user.

### SUMMARY

The present technology may provide data visualization with the capability to substitute elements for groups of clustered data in a graphical interface. When large numbers of data points are to be displayed in an interface, one or more groupings may be identified within the data. A grouping may be two or more data points that exist close together in the two or three dimensional space illustrated in the visualization interface. Typically, a grouping may consist of many more than two data points, but for example may be ten, hundreds, millions, or more data points. Once the groupings are identified and created, an element representing each grouping may be displayed in the visualization interface along with data points not associated with a grouping. A user may select a grouping to see additional information about the grouping, such as a zoomed-in view of the data points making up the grouping. Similarly, a user may select a portion of the data points that make up a grouping to display the element and zoom out for a broader view of the data.

An embodiment may perform a method for displaying data. A two or three dimensional image of data within a graphical portion of a visualization interface may be provided. The data may include a plurality of data points. The data image may include one or more data points of the plurality of data points and an element representing two or more data points of the plurality of data points. A selection of the element may be received through the graphical portion of the interface. Additional information may be provided for the selected element through the graphical portion of the interface.

An embodiment may include a system for displaying data. The system may include a processor, a memory, and one or more modules stored in memory. The one or more modules may be executed by the processor to provide a three dimensional image of data within a graphical portion of a visualization interface, the data including a plurality of data points, the data image including one or more data points of the plurality of data points and an element representing two or more data points of the plurality of data points, receive a selection of the element through the graphical portion of the interface, and provide additional information for the selected element through the graphical portion of the interface.

### BRIEF DESCRIPTION OF THE DRAWINGS

FIG. 1 is a system for processing and visualizing data.

FIG. 2 is a method for processing and visualization data.

FIG. 3 is a method for rendering volumes in a visualization.

FIG. 4 is a visualization interface having a plurality of data points.

FIG. 5A is a visualization interface having data points and an element representing a plurality of data points.

FIG. 5B is a visualization interface having data points associated with a grouping.

FIG. 6 is another visualization interface having data points and an element representing a plurality of data points.

FIG. 7 provides a computing device for implementing the present technology.

### DETAILED DESCRIPTION

A visualization of data is provided with the capability to interactively select the orientation of one or more axis used to display data. Data to be visualized is accessed by a data visualization application. The data may be structured or unstructured, filtered and analyzed. The accessed data may be displayed through an interface of the visualization application for a user. The coordinate system for displaying the data may also be displayed.

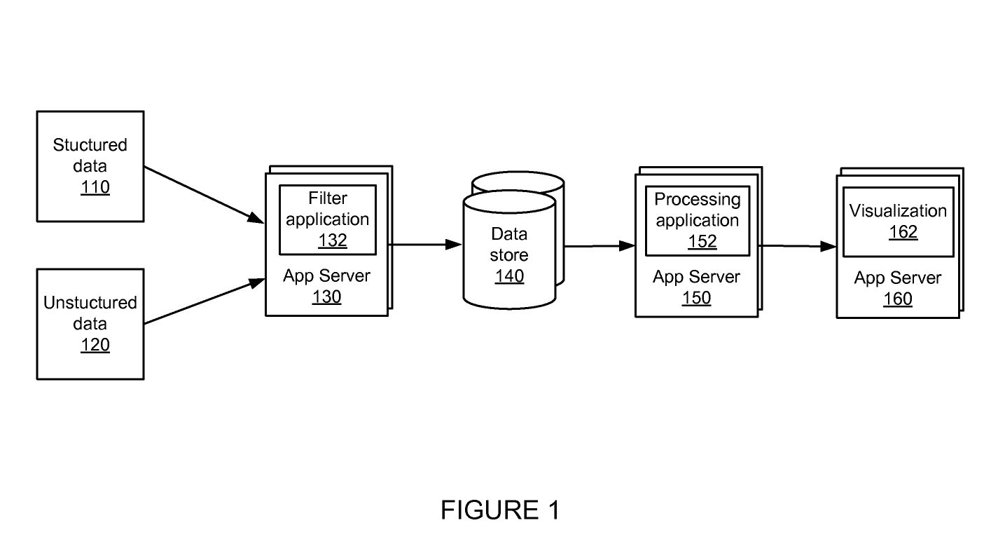

FIG. 1 is a system for processing and visualizing data. The system of FIG. 1 includes structured data 110, unstructured data 120, application servers 130, 150 and 160, and data store 140.

Structured data 110 (RDMS data) may include data items stored in tables. The structured data may be stored in a relational database, and may be formally described and organized according to a relational model. Structured data 110 may be data which can be managed using a relational database management system and may be accessed by application server 130.

Unstructured data may include data that does not include a predefined data model or does not fit into relational tables as structured data 110. Unstructured data may include text, dates, numbers, facts and other data, including email, media and documents. Unstructured data may also include lists or other data associated with web page clicks, shopping cart data, and other data. Unstructured data may be accessed by application server 130.

Application server may include one or more servers which receive and access structured data 110 and unstructured data 120. Filter application 132 may be stored and executed on application server 130, and may be executed to ingest and the structured and unstructured data. Filter application 132 may apply filters, intelligence, or other processes to select a subset of the data received and/or accessed.

Data store 140 may include one or more data stores which receive data which has been filtered by filter application 132. Data stores 140 may include SQL servers, NoSQL servers, and other servers. The data may be stored in these servers until they are accessed for processing.

Application server 150 may include one or more servers which receive and/or access data stored in data store 140. Processing application 152 may be stored on application server 150. When executed, processing application 152 may access filtered data from data store 140 and analyze the data for trends, patterns, a particular data of interest, or other data desired for reporting. For example, processing application 152 may be implemented by “Apache Hadoop” software, which is an open source software application which provides a distributed application for analyzing data.

Once data is analyzed, visualization program 162 located on application server 160 may report the data to a user. The data may be provided in many forms, such as reports, visualizations, and other formats. For example, visualization application 162 may provide data in a three dimensional graphical visualization format. In some embodiments, processing application 152 and visualization module 162 may be implemented as part of a client server tool set for extracting data, mining data with analytical algorithms, and providing interactive visualization input.

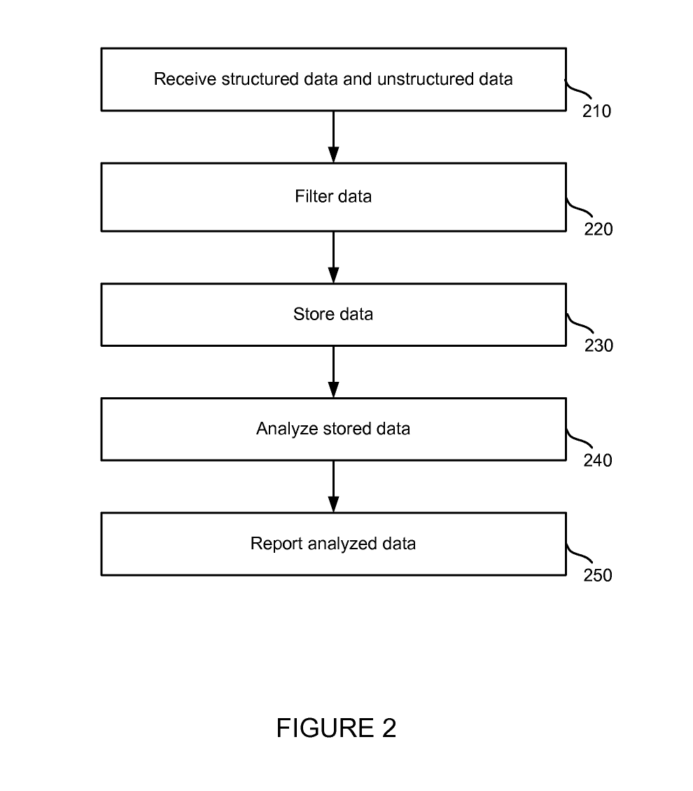

FIG. 2 is a method for analyzing and reporting data. The method of FIG. 2 may be performed by the system of FIG. 1. First, structured data and unstructured data may be received at step 210. The data may be received by filter application 132 on application server 130. The received data may be filtered at step 220. Filter application 132 may filter the data by time sampling, applying intelligence, and other methods to result in a subset of the entire set of the received data.

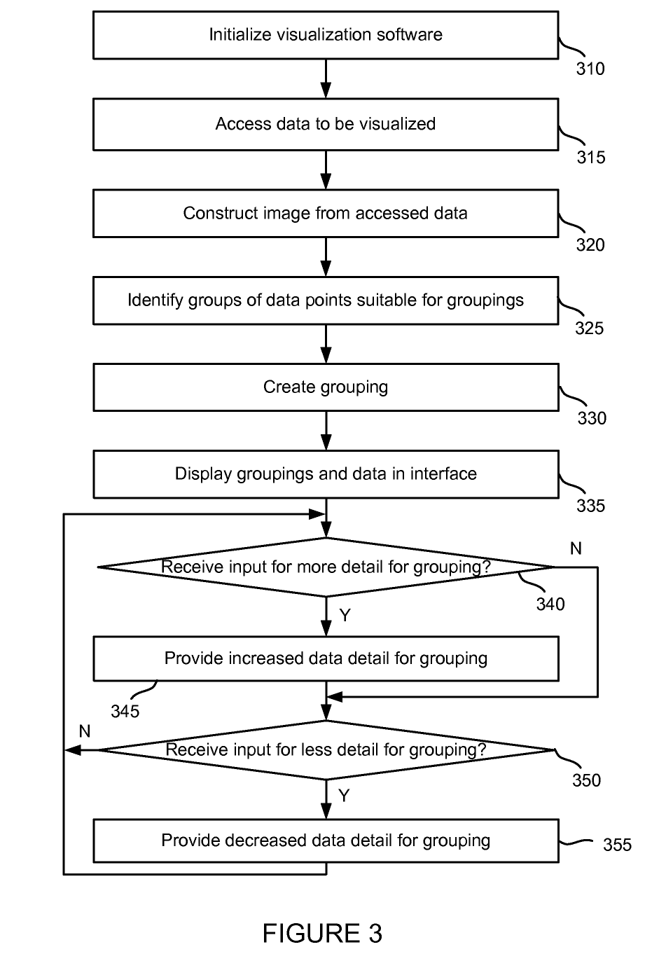

Filtered data may be stored at step 230. The data may be stored based on the type of data it is. For example, structured data may be stored in a SQL database and unstructured data may be stored in a NoSQL database. The stored data may be analyzed at step 240. Analyzing the data may include looking for trends, patterns, or otherwise processing the stored data to determine a subset of data to report to a user. Analyzing the data may be performed by processing application 152 on application server 150. Once the stored data is analyzed, the data can be reported at step 250. The data may be reported through an interactive visualization, reports, or other methods that may be useful to a user. The visualization may present a three dimensional graph of data and allow the coordinate system axis to be manipulated by a user. Step 250 is discussed in more detail with respect to FIG. 3.

FIG. 3 is a method for providing a visualization of data. The method of FIG. 3 may provide more detail for step 250 of the method of FIG. 2. In embodiments, visualization application 162 may perform the steps of FIG. 3. The visualization application 162 may extract stored data, mine data for desired information, and provide an interaction visualization of the data.

First, visualization software is initialized at step 310. Initializing the data may include executing the software, identifying what data to retrieve, and other configurations of the software. Data to be visualized may be accessed at step 320. The data may be accessed locally or remotely, for example from data store 140.

An image may be constructed from the accessed data at step 320. The image may actually be represented as an array of data points in a two or three dimensional virtual space. Groups of data points suitable for groupings are identified at step 325. Data points may be suitable for grouping may be identified in several ways. For example, data points may be grouped if they are within a multi-dimensional volume with the virtual space which has a density greater than a threshold density. In some embodiments, data points may be suitable for grouping if they are within a specified volume with respect to the overall volume occupied by all the data points. Data points may be suitable for grouping if they are within a specified volume and have a certain connection with each other, such as similarity, origin, type of data, and so on. Once groups of data points have been identified, the groupings are created at step 330. Creating the grouping may include assigning an identifier to the grouping and storing the list of data points with the grouping number.

The grouping may be displayed along with ungrouped data points at step 335. The appearance of the grouping may be configured based on the data points that comprise the grouping. For example, the grouping color, transparence, shading, and so forth may be based on the density of the grouping, the type of data, or other data information. A grouping may be displayed as a graphical element in the display portion. The element may have any shape and size. In some embodiments, the element may have a general shape that roughly outlines the volume of space associated with the corresponding groupings data points. The element may be displayed in any way, for example in shape, color, and so forth, that allows a user to differentiate the element from a data point.

A determination is made at step 340 as to whether input is received for more detail for a particular element (representing a grouping of data points). The input may include a positioning a cursor over the grouping displayed in the graphical portion of a visualization interface, positioning a cursor over the grouping and receiving a mouse-button click input, and/or other input. If no input is received for a particular grouping element, the method of FIG. 3 continues to step 350. If input is received at step 340, increased detail is provided for the data points associated with the selected element at step 345.

The increased data may include information about the data in graphical form, textual form, audio form, or a combination of these. The additional information may be provided in place of the element displayed in the visualization, outside of the element, or a combination of locations. For example, upon receiving input selecting an element, the graphical image of the visualization interface may zoom into the portion of the image associated with the element. The zoomed-in portion of the interface may then display the data points, or at least some of the data points in the grouping.

When providing the information, a visualization module may retrieve data information associated with the particular element. Once retrieved, the interface of the visualization application may be updated with the corresponding data points and/or sub-elements that make-up the selected element.

A selection of an element may provide more information in many steps, corresponding to many selections. For example, a first selection of an element may result in providing a plurality of data points within the element and two other elements representing sub-groupings of data points within the overall grouping. Selection of an element associated with a sub-grouping may result in display of two additional elements associated with another level of sub-groupings.

A determination may then be made as to whether input is received for less detail for a particular grouping at step 350. Once an element is received and additional information is provided, a user may select to return to the previous level of information regarding the grouping. Put another way, once a user zooms in to view grouping data points for an element, the user may provide input to zoom out to return to the high level view. If no input is received to revert back to less detail for a selected grouping, the method of FIG. 3 returns to step 340. If input is received at step 350, the interface is updated to provide less information, such as for example a zoom-out operation and replacing the data points with an element, and the method of FIG. 3 returns to step 340.

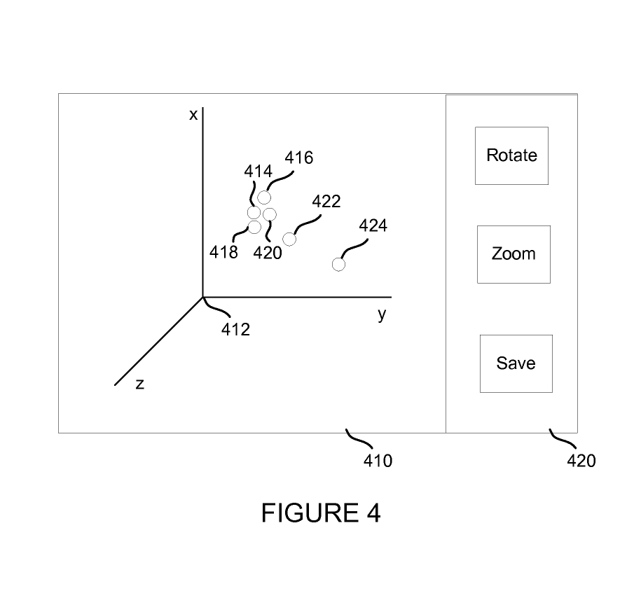

FIGS. 4-6 illustrate examples of visualization interfaces for displaying three dimensional data. FIG. 4 is a visualization interface having a plurality of data points. The visualization interface of FIG. 4 provides a graphics portion 410 and a control portion 420. The control portion 420 includes buttons for performing functions, such as for example a rotate button, zoom button and save button. Graphics portion 410 includes a graphical coordinate system with an x, y, z axes 412, and data points 414, 416, 418, 420, 422 and 424. Data points 414-420 are positioned relatively close together. As such, data points 414-420 may form a grouping.

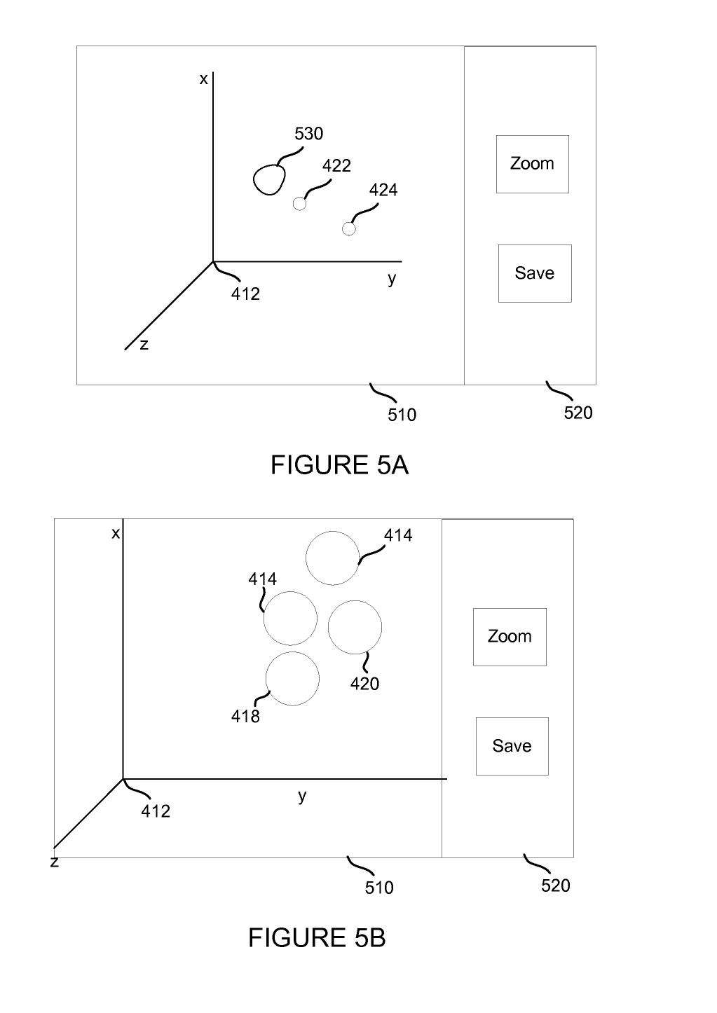

FIG. 5A is a visualization interface having data points and an element representing a plurality of data points. The interface of FIG. 5A is similar to that of FIG. 4 except that data points 414-420 which formed a grouping are replaced with element 530. The element is provided in place of the multiple data points.

FIG. 5B is a visualization interface having data points associated with a grouping. When element 530 is selected in the interface of FIG. 5A, the interface may be zoomed-in to the area associated with element 530, and the element may be replaced with information associated with the data points which make up element 530. In FIG. 5B, the display has been zoomed-in at the location of the selected element and each data point making up the element is displayed.

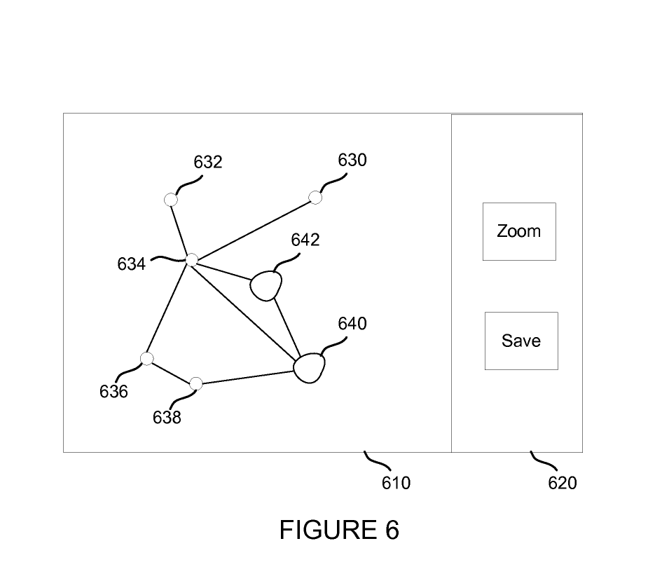

FIG. 6 is another visualization interface having data points and an element representing a plurality of data points. Data points 630, 632, 634, 636, and 638 and elements 640 and 642 are not displayed in an x,y,z coordinate system as in FIGS. 4-5B, but rather with displayed relationships among the data points and elements. For example, data point 634 has a relationship with (in clockwise order) data point 632, data point 630, elements 642 and 640, and data point 636, as shown by the lines between data point 634 and the listed data points and elements.

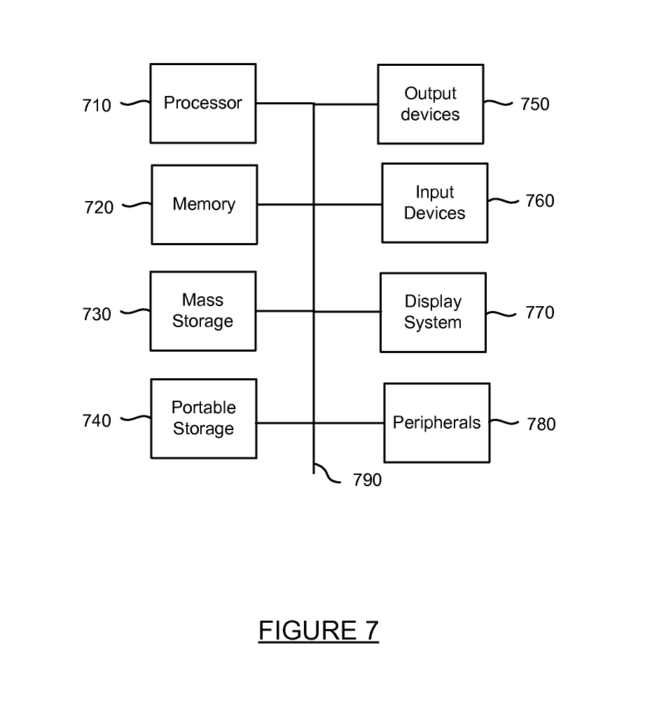

FIG. 7 provides a computing device for implementing the present technology. Computing device 700 may be used to implement devices such as for example application servers 130, 150 and 160 and data stores 140. FIG. 7 illustrates an exemplary computing system 700 that may be used to implement a computing device for use with the present technology. System 700 of FIG. 7 may be implemented in the contexts of the likes of client computer 210, servers that comprise services 230-250 and 270-280, application server 260, and data store 267. The computing system 700 of FIG. 7 includes one or more processors 710 and memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Input may also include a touch a touch-sensitive screen. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for displaying data, comprising:
providing a two or three dimensional image of data within a graphical portion of a visualization interface, the data including a plurality of data points;
the data image including one or more data points of the plurality of data points and an element representing a two or more data points of the plurality of data points;
receiving a selection of the element through the graphical portion of the interface; and
providing additional information for the selected element through the graphical portion of the interface.

2. The method of claim 1, the additional information including a graphical display of the two or more data points of the group of data.

3. The method of claim 1, wherein providing additional information includes:
performing a zoom-in operation on the portion of the three dimensional image associated with the selected element; and
displaying data points of the group of data in the zoomed-in portion of the three dimensional image.

4. The method of claim 3, further comprising:
receiving a selection of at least a portion of the two or more data points associated with the element; and
displaying the element in place of the two or more data points associated with the element.

5. The method of claim 1, wherein the data image illustrates connections between the one or more data points and the element.

6. The method of claim 5, wherein the connections includes one or more lines drawn between the one or more data points and the element.

7. The method of claim 1, wherein the data points and element are displayed within an x,y,z coordinate system.

8. A computer readable storage medium having embodied thereon a program, the program being executable by a processor to perform a method for displaying data, the method comprising:
providing a three dimensional image of data within a graphical portion of a visualization interface, the data including a plurality of data points;
the data image including one or more data points of the plurality of data points and an element representing a two or more data points of the plurality of data points;
receiving a selection of the element through the graphical portion of the interface; and
providing additional information for the selected element through the graphical portion of the interface.

9. The computer readable storage medium of claim 8, the additional information including a graphical display of the two or more data points of the group of data.

10. The computer readable storage medium of claim 8, wherein providing additional information includes:
performing a zoom-in operation on the portion of the three dimensional image associated with the selected element; and
displaying data points of the group of data in the zoomed-in portion of the two or three dimensional image.

11. The computer readable storage medium of claim 10, the method further comprising:
receiving a selection of at least a portion of the two or more data points associated with the element; and
displaying the element in place of the two or more data points associated with the element.

12. The computer readable storage medium of claim 8, wherein the data image illustrates connections between the one or more data points and the element.

13. The computer readable storage medium of claim 12, wherein the connections includes one or more lines drawn between the one or more data points and the element.

14. The computer readable storage medium of claim 8, wherein the data points and element are displayed within an x,y,z coordinate system.

15. A system for displaying data, comprising:
a processor;
memory;
one or more modules stored in memory and executed by the processor to provide a three dimensional image of data within a graphical portion of a visualization interface, the data including a plurality of data points, the data image including one or more data points of the plurality of data points and an element representing a two or more data points of the plurality of data points, receive a selection of the element through the graphical portion of the interface, and provide additional information for the selected element through the graphical portion of the interface.

16. The system of claim 15, the additional information including a graphical display of the two or more data points of the group of data.

17. The system of claim 1, wherein the one or more modules are executable to:
performing a zoom-in operation on the portion of the three dimensional image associated with the selected element; and
displaying data points of the group of data in the zoomed-in portion of the three dimensional image.

18. The system of claim 17, wherein the one or more modules are executable to:
receive a selection of at least a portion of the two or more data points associated with the element; and
display the element in place of the two or more data points associated with the element.

19. The system of claim 15, wherein the data image illustrates connections between the one or more data points and the element.

20. The system of claim 19, wherein the connections includes one or more lines drawn between the one or more data points and the element.

21. The system of claim 15, wherein the data points and element are displayed within an x,y,z coordinate system.
